(19) United States
(12) Patent Application Publication
(10) Pub. No.: US 2025/0315302 A1
(43) Pub. Date: Oct. 9, 2025

(54) METHOD AND SYSTEM FOR GENERATING RESPONSE DATA USING GENERATIVE AI MODEL

(71) Applicant: SAMSUNG SDS CO., LTD., Seoul (KR)

(72) Inventor: Kwang Yeol LEE, Seoul (KR)

(73) Assignee: SAMSUNG SDS CO., LTD., Seoul (KR)

(21) Appl. No.: 19/080,140

(22) Filed: Mar. 14, 2025

(30) Foreign Application Priority Data
Apr. 4, 2024 (KR) 10-2024-0046126
May 29, 2024 (KR) 10-2024-0070312

(51) Int. Cl. G06F 9/50

(52) U.S. Cl. CPC G06F 9/5027

(57) ABSTRACT

A method for generating response data includes determining an intention corresponding to request content received from a user terminal, by analyzing the request content; defining a task execution task to achieve the intention; selecting an AI model for each of first and second tasks from a predetermined pool of a plurality of generative AI models; generating a first output by inputting the first task into a first generative AI model selected for the first task; generating a second output by inputting the second task into a second generative AI model selected for the second task; and generating response data for the request content by aggregating the first and second outputs. The first generative AI model is a fine-tuned model obtained using training data from a first domain, and the second generative AI model is a fine-tuned model obtained using training data from a second domain different from the first domain.

### CROSS-REFERENCE TO RELATED APPLICATIONS

This application claims priority from Korean Patent Application Nos. 10-2024-0046126 filed on Apr. 4, 2024 and 10-2024-0070312 filed on May 29, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for generating response data using a generative artificial intelligence (AI) model, and more specifically, to a method and system for generating response data using a plurality of generative AI models.

### 2. Description of the Related Art

Prompt engineering is a technique for dynamically generating responses in interactive systems based on user input. By utilizing large-scale language models (LLMs), this technique enables interaction with users while continuously improving the performance of the models.

Retrieval-Augmented Generation (RAG) is an emerging technology for natural language generation and understanding tasks. This technology combines a conversational artificial intelligence (AI) model, such as Generative Pre-trained Transformer (GPT), with a retrieval system to generate richer and more accurate responses.

Generative AI is a technology that generates new data, images, music, and text based on given input. Such generative AI systems are primarily based on deep learning techniques and typically include models such as Generative Adversarial Networks (GANs) and natural language generation models.

### SUMMARY

An objective of the present disclosure is to provide a method and a system for analyzing the intention of a query from request content input by a user and generating response data using a generative artificial intelligence (AI) model.

Another objective of the present disclosure is to provide a method and system for assigning different tasks to a plurality of generative AI models, aggregating the results of these tasks from the plurality of generative AI models, and generating response data corresponding to request content input by a user.

Yet another objective of the present disclosure is to provide a method and system for receiving each user's feedback on response data and generating response data that reflects the received feedback to match each user's preferences.

The objectives of the present disclosure are not limited to those mentioned above, and other objectives not explicitly stated will be clearly understood by those skilled in the art based on the following description.

According to an aspect of the present disclosure, there is provided a method for generating response data using a generative artificial intelligence (AI) model, performed by a computing system. The method may comprise determining an intention corresponding to request content received from a user terminal, by analyzing the request content; defining a task execution task to achieve the intention, the task execution task including a first task and a second task; selecting an AI model for each of the first and second tasks from a predetermined pool of a plurality of generative AI models; generating a first output by inputting the first task into a first generative AI model selected as an AI model responsible for the first task; generating a second output by inputting the second task into a second generative AI model selected as an AI model responsible for the second task; and generating response data for the request content by aggregating the first and second outputs, wherein the first generative AI model is a fine-tuned model obtained using training data from a first domain, and the second generative AI model is a fine-tuned model obtained using training data from a second domain different from the first domain.

In some embodiments, the determining the intention may comprise retrieving usage history of a user of the user terminal by querying a personalized user database for the user; and generating required information for defining the task execution task by referencing the retrieved usage history.

In some embodiments, the generating the required information may comprise transmitting a query to the user terminal to supplement the required information; and generating the required information by further referencing a response to the query from the user terminal.

In some embodiments, the defining the task execution task may comprise generating a task execution plan that includes a sequential workflow for the first and second tasks to achieve the determined intention, and the task execution plan includes sequential execution of the first and second tasks.

In some embodiments, the generating the task execution plan may comprise updating the task execution plan by referencing at least one of execution history for each of the first and second tasks, operational guidelines, or a personalized user database for the user.

In some embodiments, the selecting the AI model for each of the first and second tasks may comprise retrieving usage history of a user of the user terminal by querying a personalized user database for the user; acquiring parameters for generating a first text-based prompt instructing the execution of the first task by referencing the retrieved usage history; and generating a first prompt based on the acquired parameters.

In some embodiments, the generating the first output may comprise acquiring knowledge data required to perform the first task; and generating the first output by inputting the acquired knowledge data into the first generative AI model.

In some embodiments, the generating the second output may comprise generating the second output by further inputting the first output into the second generative AI model.

In some embodiments, the generating the response data may comprise determining whether each of the first and second outputs matches the intention; and re-performing the selecting the AI model for each of the first and second tasks when at least one of the first and second outputs does not match the intention.

In some embodiments, the method may further comprise storing feedback data regarding a behavior of a user of the user terminal with respect to the response data, in a personalized user database for the user.

According to another aspect of the present disclosure, there is provided a system for generating response data using a generative artificial intelligence (AI) model. The system may comprise a communication interface; a memory in which a computer program is loaded; and at least one processor configured to execute the computer program, wherein the computer program includes instructions for performing operations of: determining an intention corresponding to request content received from a user terminal, by analyzing the request content; defining a task execution task to achieve the intention, the task execution task including a first task and a second task; selecting an AI model for each of the first and second tasks from a predetermined pool of a plurality of generative AI models; generating a first output by inputting the first task into a first generative AI model selected as an AI model responsible for the first task; generating a second output by inputting the second task into a second generative AI model selected as an AI model responsible for the second task; and generating response data for the request content by aggregating the first and second outputs, the first generative AI model is a fine-tuned model obtained using training data from a first domain, and the second generative AI model is a fine-tuned model obtained using training data from a second domain different from the first domain.

In some embodiments, the operation of determining the intention may comprise retrieving usage history of a user of the user terminal by querying a personalized user database for the user; and generating required information for defining the task execution task by referencing the retrieved usage history.

In some embodiments, the operation of generating the required information may comprise transmitting a query to the user terminal to supplement the required information; and generating the required information by further referencing a response to the query from the user terminal.

In some embodiments, the operation of defining the task execution task may comprise generating a task execution plan that includes a sequential workflow for the first and second tasks to achieve the determined intention, and the task execution plan may include sequential execution of the first and second tasks.

In some embodiments, the operation of generating the task execution plan may comprise updating the task execution plan by referencing at least one of execution history for each of the first and second tasks, operational guidelines, or a personalized user database for the user.

In some embodiments, the operation of selecting the AI model for each of the first and second tasks may comprise retrieving usage history of a user of the user terminal by querying a personalized user database for the user; acquiring parameters for generating a first text-based prompt instructing the execution of the first task by referencing the retrieved usage history; and generating a first prompt based on the acquired parameters.

In some embodiments, the operation of generating the first output may comprise acquiring knowledge data required to perform the first task; and generating the first output by inputting the acquired knowledge data into the first generative AI model.

In some embodiments, the operation of generating the second output may comprise generating the second output by further inputting the first output into the second generative AI model.

In some embodiments, the operation of generating the response data may comprise determining whether each of the first and second outputs matches the intention; and-performing the operation of selecting the AI model for each of the first and second tasks when at least one of the first and second outputs does not match the intention.

According to still another aspect of the present disclosure, there is provided a computer program stored in a computer-readable recording medium for executing, by being combined with a computing device, the steps of: determining an intention corresponding to request content received from a user terminal, by analyzing the request content; defining a task execution task to achieve the determined intention, the task execution task including a first task and a second task; selecting an artificial intelligence (AI) model for each of the first and second tasks from a predetermined pool of a plurality of generative AI models; generating a first output by inputting the first task into a first generative AI model selected as an AI model responsible for the first task; generating a second output by inputting the second task into a second generative AI model selected as an AI model responsible for the second task; and generating response data for the request content by aggregating the first and second outputs, wherein the first generative AI model is a fine-tuned model obtained using training data from a first domain, and the second generative AI model is a fine-tuned model obtained using training data from a second domain different from the first domain.

According to some embodiments of the present disclosure, by analyzing request content entered by a user through a user terminal to clearly identify the user's query intention, optimal response data for each user can be generated.

Additionally, according to some embodiments of the present disclosure, by defining a task execution task for generating response data for the request content received from the user terminal, and assigning each task included in the task execution task to a generative AI model best suited to handle it, response data can be generated more effectively in alignment with the user's intention.

Furthermore, according to some embodiments of the present disclosure, the generative AI system can subsequently provide response data that better satisfies each user by referencing feedback data on response data and assessing user satisfaction with the response data.

Moreover, according to some embodiments of the present disclosure, by searching the user database for usage history related to tasks most similar to the request content entered by the user, the user's intention can be accurately identified, and tasks necessary for achieving the identified intention can be defined.

In addition, according to some embodiments of the present disclosure, if the intention determined through the required information for defining the task execution task is unclear, the response generation system can clarify the user's intention behind the received request content by generating a query in natural language. Thus, according to the present embodiment, user satisfaction with response data generated by the generative AI system can be improved.

Also, according to some embodiments of the present disclosure, by determining the optimal parameters for each task included in the task execution task based on the user's usage history and instructing the generative AI model to perform each task based on the determined parameters, an optimal output for each task can be generated. Ultimately, response data aligned with the user's intention can be generated. Consequently, according to the present embodiment, user satisfaction with the service of the generative AI system can be enhanced.

Additionally, according to some embodiments of the present disclosure, by referencing not only data stored in the user database, but also execution history and operational guidelines, the response generation system can adjust the output data for each task included in the task execution task, allowing for the generation of optimal response data. Consequently, according to the present embodiment, user satisfaction with the service of the generative AI system can be improved.

Furthermore, according to some embodiments of the present disclosure, by converting the task execution task into a task execution plan that comprises a sequential workflow, and ensuring that each generative AI model fully executes its assigned task, final response data aligned with the user's intention can be generated. That is, by selecting the optimal generative AI model for each task to generate an output, and aggregating the generated outputs, final response data that accurately reflect the user's intention can be created. Consequently, the user experience with the generative AI system can be maximized.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a system configuration diagram for explaining the configuration and operation of a multi-generative artificial intelligence (AI) system according to some embodiments of the present disclosure;

FIG. 2 is a flowchart illustrating a method for generating response data using a generative AI model according to an embodiment of the present disclosure;

FIG. 3 is a diagram illustrating the screen configuration of a generative AI system for generating response data, referenced in some embodiments of the present disclosure;

FIG. 4 is a detailed flowchart illustrating some of the steps of the method for generating response data using a generative AI model, as explained with reference to FIG. 2;

FIG. 5 is a diagram illustrating request content received from a user terminal according to some embodiments of the present disclosure;

FIG. 6 is a detailed flowchart illustrating some of the steps of the method for generating response data using a generative AI model, as explained with reference to FIG. 4;

FIG. 7 is a detailed flowchart illustrating some of the steps of the method for generating response data using a generative AI model, as explained with reference to FIG. 2;

FIG. 8 is a diagram illustrating a method for generating a task execution plan and corresponding prompts, performed according to some embodiments of the present disclosure;

FIGS. 9 and 10 are detailed flowcharts illustrating some of the steps of the method for generating response data using a generative AI model, as explained with reference to FIG. 4; and

FIG. 11 is a hardware configuration diagram of a computing device according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

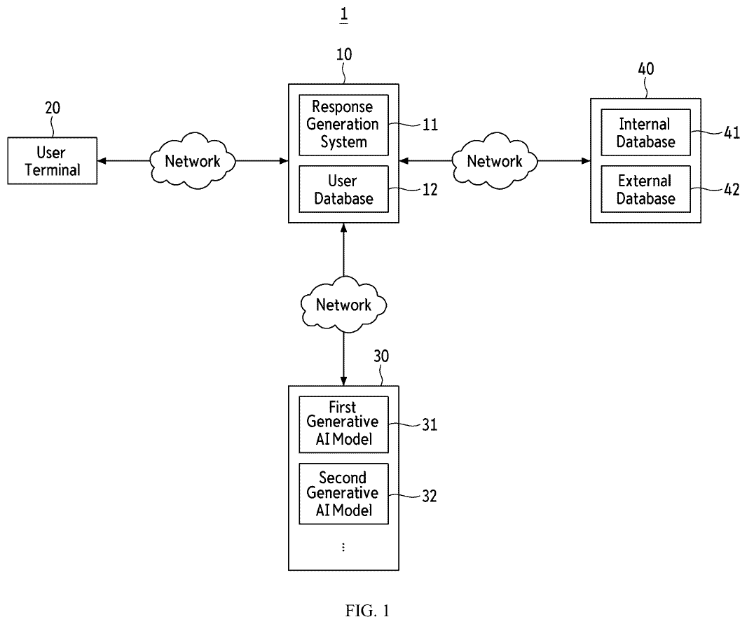

The configuration and operation of a multi-generative artificial intelligence (AI) system according to some embodiments of the present disclosure will hereinafter be described with reference to FIG. 1. FIG. 1 is a system configuration diagram for explaining the configuration and operation of a multi-generative AI system according to some embodiments of the present disclosure.

Referring to FIG. 1, a multi-generative AI system 1 may include a generative AI system 10, a user terminal 20, a generative AI model pool 30, and a knowledge data storage 40. In some embodiments, the multi-generative AI system 1 may further include modules/devices/systems that are not illustrated in FIG. 1. Alternatively, the multi-generative AI system 1 may be configured such that at least some of its components illustrated in FIG. 1, such as the generative AI system 10, the user terminal 20, the generative AI model pool 30, and the knowledge data storage 40, are omitted.

The user terminal 20 may transmit request content entered by a user to the generative AI system 10. The request content may include various types of content, such as text, images, and videos. The user terminal 20 may display a prompt input area where the user can enter the request content and a screen user interface (UI) where response data generated by the generative AI system 10 is displayed.

The generative AI system 10 may include a response generation system 11 and a user database 12. In some embodiments, the generative AI system 10 may be configured to further include modules/devices/systems that are not illustrated in FIG. 1. Alternatively, the generative AI system 10 may be configured such that such that at least some of its components illustrated in FIG. 1, such as the response generation system 11 and the user database 12, are omitted.

The response generation system 11 may analyze the request content received from the user terminal 20 and determine an intention corresponding to the request content based on the analysis results. The user database 12, which refers to a personalized database for each user, may store usage history related to the use of the generative AI system 10 by each user. The response generation system 11 may retrieve a specific user's usage history stored in the user database 12 and determine the intention corresponding to the request content by referring to the retrieved usage history.

The response generation system 11 may define a task execution task for achieving the determined intention and select a specific generative AI model from the generative AI model pool 30 to process each task included in the task execution task.

The response generation system 11 may input each task included in the task execution task into the selected generative AI model and aggregate the respective output generated as a result of the input, thereby generating response data for the request content received from the user terminal 20.

Specifically, the response generation system 11 may include an orchestrator that controls the generation of response data and an internal generative AI model that generates responses under the control of the orchestrator. The orchestrator may determine the intention corresponding to the request content, define the task execution task for achieving the determined intention, and select a specific generative AI model to process each task included in the task execution task. Subsequently, the internal generative AI model may input each task included in the task execution task into the specific generative AI model and aggregate the respective output generated as a result of the input, thereby generating the response data for the request content received from the user terminal 20.

In the present disclosure, the orchestrator and the internal generative AI model will be collectively referred to as the response generation system 11 without distinguishing between them.

When generating an output by inputting each task included in the task execution task into the specific generative AI model, the response generation system 11 may obtain knowledge data from the knowledge data storage 40 to generate the output. The knowledge data may refer to information required for generating the output. The knowledge data storage 40 may include an internal database 41, which is maintained and managed by the entity operating the generative AI system 10, and an external database 42, which is maintained and managed by an entity different from that operating the generative AI system 10. That is, when generating output for constructing final response data, the response generation system 11 may utilize both internal and external information by inputting each task included in the task execution task into the specific generative AI model.

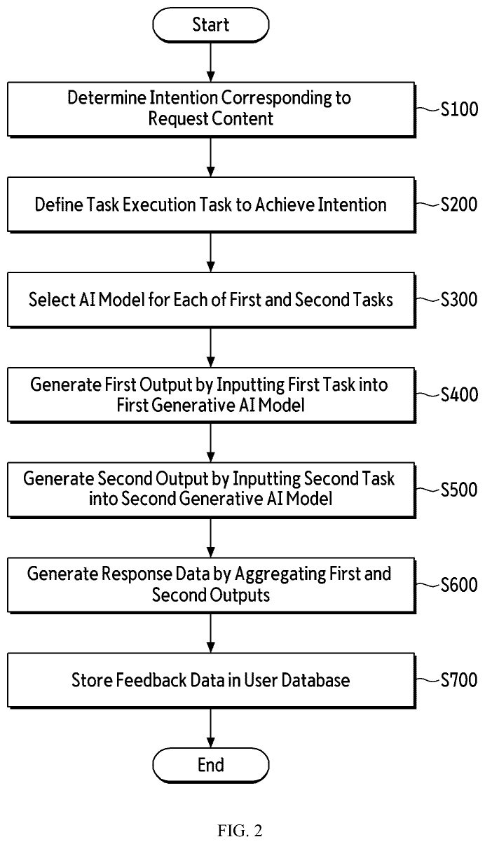

A method for generating response data using a generative AI model according to an embodiment of the present disclosure will hereinafter be described with reference to FIG. 2. FIG. 2 is a flowchart illustrating a method for generating response data using a generative AI model according to an embodiment of the present disclosure.

For convenience, the following description assumes that all steps/operations of methods to be described below are performed by the response generation system 11. Accordingly, if the subject of a specific step/operation is omitted, the specific step/operation may be understood as being performed by the response generation system 11.

Referring to FIG. 2, the response generation system 11 may analyze request content received from the user terminal 20 and determine an intention corresponding to the request content (S100). The request content may include various types of content, such as text, images, and videos. A detailed description of the request content will be provided later with reference to FIG. 5.

When the request content is an image, the response generation system 11 may perform image analysis. In this case, the response generation system 11 may perform image analysis on the request content, using Optical Character Recognition (OCR) technology and Deep Document Understanding (DDU) analysis technology, thereby extracting information on text or an image within a document. The information on the image may include detailed data on an object represented by the image. OCR technology and DDU analysis technology are already well known in the field to which the present disclosure pertains, and thus, detailed descriptions thereof will be omitted.

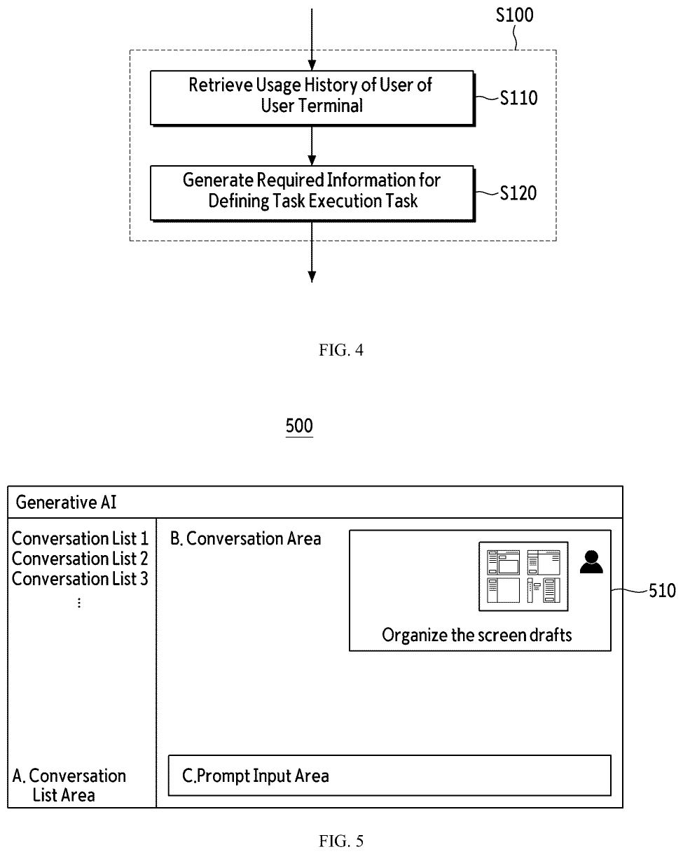

The intention corresponding to the request content may refer to an intention that reflects both a request explicitly entered by the user and any implicit request that is not entered by the user but can be inferred. That is, the intention corresponding to the request content may be identified by referring to the user's usage history as well as the context of the conversation. A detailed description of how the response generation system 11 determines the intention will be provided later with reference to FIGS. 4 through 6.

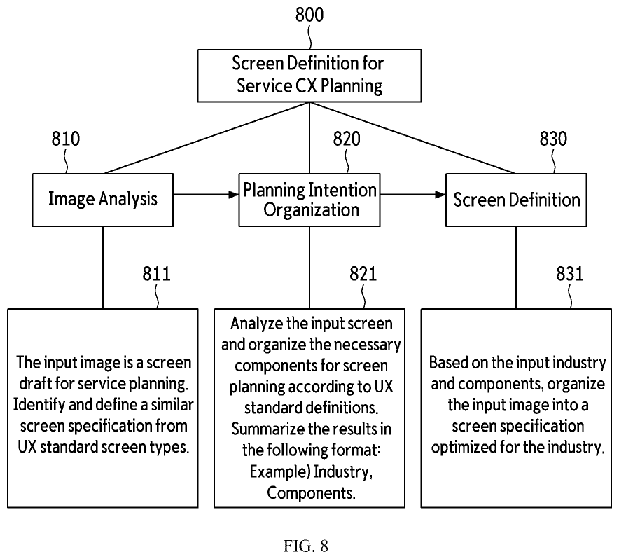

Thereafter, the response generation system 11 may define a task execution task to achieve the intention determined in step S100 (S200). The task execution task may include a first task and a second task. The response generation system 11 may organize the intention determined in step S100 into a checklist and define a task execution task that include specific tasks based on the checklist. In the present disclosure, the checklist may be used interchangeably with required information for defining a task execution task. A detailed description of how the response generation system 11 defines a task execution task will be provided later with reference to FIGS. 7 and 8.

Thereafter, the response generation system 11 may select first and second AI models for the first and second tasks, respectively, from a predetermined pool of a plurality of generative AI models (S300). The response generation system 11 may generate text-based prompts instructing the execution of the first and second tasks. That is, the response generation system 11 may generate optimized prompts so that the first and second generative AI models may perform the first and second tasks, respectively, according to the determined intention, and may then input the generated prompts into the first and second generative AI models. A detailed description of how the response generation system 11 generates prompts will be provided with reference to FIG. 8.

Thereafter, the response generation system 11 may input the first task included in the task execution task into the first generative AI model, thereby generating a first output (S400).

Likewise, the response generation system 11 may input the second task included in the task execution task into the second generative AI model, thereby generating a second output (S500).

In this case, the first generative AI model may be a fine-tuned model obtained using training data from a first domain, and the second generative AI model may be a fine-tuned model obtained using training data from a second domain different from the first domain. That is, the first generative AI model may be an optimal generative AI model for performing the first task, and the second generative AI model may be an optimal generative AI model for performing the second task. For example, if the first task relates to image analysis, the second task relates to screen definition, the first generative AI model is optimized for image analysis, and the second generative AI model is optimized for screen definition, the response generation system 11 may input the first task into the first generative AI model so that the first generative AI model may perform the first task, and input the second task into the second generative AI model so that the second generative AI model may perform the second task.

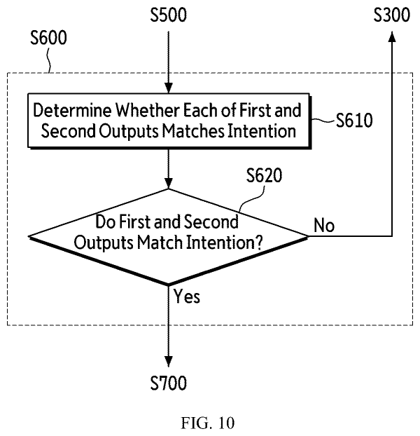

Thereafter, the response generation system 11 may generate response data corresponding to the request content received from the user terminal 20 (S600) by aggregating the first and second outputs. The response data may be in text format or image format. That is, the format of the response data may vary depending on the request content provided by the user. A detailed description of how response data is generated will be provided later with reference to FIG. 10.

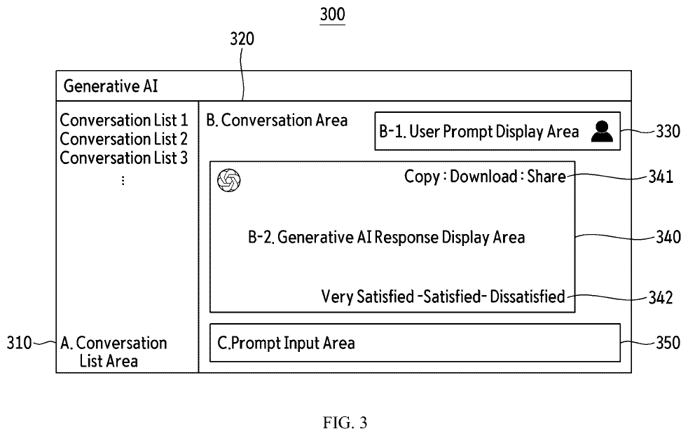

Thereafter, the response generation system 11 may store feedback data regarding the behavior of the user of the user terminal 20 with respect to the response data, in a user-specific personalized user database 12 for the user (S700). A detailed description of how feedback data is stored in a user database will be provided later with reference to FIG. 3.

According to the aforementioned embodiment, by analyzing the request content entered by the user through the user terminal 20 and clearly identifying the user's query intention, optimized response data for each user can be generated.

Additionally, according to the aforementioned embodiment, by defining a series of tasks for task execution for generating response data corresponding to the request content received from the user terminal 20 and assigning each task to a respective generative AI model suited for handling it, response data aligned with the user's intention can be effectively generated.

The screen configuration of a generative AI system for generating response data, referenced in some embodiments of the present disclosure will hereinafter be described with reference to FIG. 3. FIG. 3 is a diagram illustrating the screen configuration of a generative AI system for generating response data, referenced in some embodiments of the present disclosure.

Specifically, FIG. 3 illustrates a UI screen 300 of the generative AI system 10 for generating response data. Referring to FIG. 3, the UI screen 300 may include a conversation list area 310, a conversation area 320, a user prompt display area 330, a generative AI system response display area 340, and a prompt input area 350. The user terminal 20 may display the UI screen 300 through a display unit.

The conversation list area 310 may be an area where the user of the user terminal 20 can view the history of queries made using the generative AI system 10. The conversation area 320 may be an area where the user of the user terminal 20 enters a query, including request content, and where the generative AI system 10 displays a response to the entered query. The user of the user terminal 20 may enter a query, including request content, in the prompt input area 350.

The generative AI system response display area 340 may be an area where the generative AI system 10 displays response data for the query, including the request content, from the user of the user terminal 20.

In one embodiment, the response generation system 11 may store feedback data regarding the behavior of the user of the user terminal 20 with respect to response data generated by the generative AI system 10, in the user database 12 for the user of the user terminal 20. Referring to FIG. 3, the response generation system 11 may store user behavior data 341 for response data usage, such as copying, downloading, and sharing, and feedback on response data, such as “Very Satisfied,” “Satisfied,” and “Dissatisfied,” in the user database 12.

According to the above embodiment, the generative AI system 10 can reference feedback data on response data, assess user satisfaction with the response data, and subsequently provide response data that better satisfies each user.

A method for determining an intention corresponding to request content according to an embodiment of the present disclosure will hereinafter be described with reference to FIG. 4. FIG. 4 is a detailed flowchart illustrating some of the steps of the method for generating response data using a generative AI model, as explained with reference to FIG. 2.

Referring to FIG. 4, the response generation system 11 may retrieve the user's usage history by querying the user database 12 for the user (S110). The usage history may refer to all usage records of queries made using the generative AI system 10 and response data generated for those queries.

Thereafter, the response generation system 11 may generate required information for defining a task execution task (S120) by referencing the usage history. The required information may refer to checklist-type data organized based on the intention determined in step S100 in FIG. 2. That is, the required information may be a checklist of items that must be performed to achieve the intention corresponding to the request content.

Request content received from the user terminal 20 according to some embodiments of the present disclosure will hereinafter be described with reference to FIG. 5. FIG. 5 is a diagram illustrating request content received from a user terminal according to some embodiments of the present disclosure.

For example, referring to FIG. 5, the response generation system 11 may receive first request content 510 from the user terminal 20, which includes image data containing multiple screen drafts and text data stating, “Organize the screen drafts.”

Thereafter, the response generation system 11 may retrieve the usage history by querying the user database 12. For example, by querying the user database 12, the response generation system 11 may retrieve a history indicating that the user of the user terminal 20 has previously performed tasks related to UX standard screen types and CX planning.

Thereafter, by referencing the retrieved history, the response generation system 11 may generate an image analysis task for image data included in the first request content 510 in FIG. 5, a planning intention organization task, and a screen definition task, as required information for defining a task execution task for the first request content 510.

According to the above embodiment, by searching the user database 12 for a usage history related to tasks most similar to the request content entered by the user, the response generation system 11 can clearly identify the user's intention behind entering the request content and define necessary tasks to achieve the identified intention.

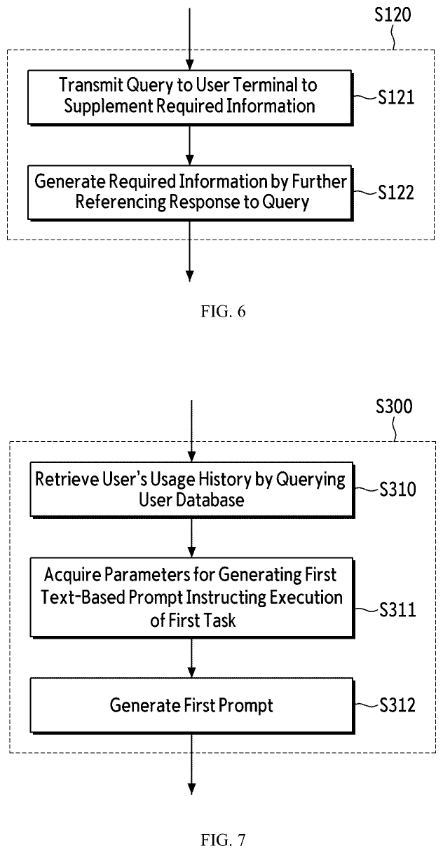

A method for generating required information for defining a task execution task according to an embodiment of the present disclosure will hereinafter be described with reference to FIG. 6. FIG. 6 is a detailed flowchart illustrating some of the steps of the method for generating response data using a generative AI model, as explained with reference to FIG. 4.

In one embodiment, the response generation system 11 may transmit a query to the user terminal 20 to supplement the required information for defining a task execution task (S121). When the intention determined using the required information generated with reference to the user's usage history, as explained with reference to FIG. 4, is unclear, the response generation system 11 may generate a query in natural language to clarify the user's intention behind the received request content. For example, if an image analysis task, a planning intention organization task, and a screen definition task can be generated as required information for defining a task execution task for the first request content 510 in FIG. 5, the response generation system 11 may transmit a supplementary query to the user terminal 20.

Subsequently, the response generation system 11 may further generate the required information (S122) by referencing the response to the query from the user terminal 20.

According to the above embodiment, when the intention determined using the required information generated with reference to the user's usage history is unclear, the response generation system 11 may generate a query in natural language to clarify the user's intention behind the received request content. Thus, according to this embodiment, user satisfaction with response data generated by the generative AI system 10 can be improved.

Meanwhile, in one embodiment, the response generation system 11 may generate a task execution plan based on the intention determined in step S100 in FIG. 2. That is, for the first and second tasks included in the task execution task, the response generation system 11 may generate a task execution plan that comprises a sequential workflow for the first and second tasks to achieve the determined intention. In this case, the task execution plan may involve sequential execution of the first and second tasks. A detailed description of how to generate a task execution plan will be provided later with reference to FIG. 8.

A method for generating a text-based prompt for each task included in a task execution plan according to an embodiment of the present disclosure will hereinafter be described with reference to FIG. 7. FIG. 7 is a detailed flowchart illustrating some of the steps of the method for generating response data using a generative AI model, as explained with reference to FIG. 2.

Referring to FIG. 7, the response generation system 11 may retrieve the user's usage history by querying the user database 12 for the user of the user terminal 20 (S310). The usage history may refer to all usage records of queries made using the generative AI system 10 and response data generated for those queries.

Thereafter, the response generation system 11 may generate parameters for generating a first text-based prompt that instructs the execution of each task included in the task execution task (S311) by referencing the usage history. That is, for each task included in the task execution task, the response generation system 11 may generate parameters that adjust the variables or settings used for prompt generation. These parameters may affect the operation of the generative AI system 10 and the results of the generated response data.

The parameters may include, for example, a model type, a token count, a temperature, and a batch size. The model type is a parameter that determines which type of model to use, such as whether to use a GPT-3 model or a specific network architecture. The token count is a parameter that determines the number of input tokens the model processes at a time. Using more tokens allows more context to be considered but increases processing time. The temperature is a parameter that controls the diversity of word selection in the generative model. Higher temperatures produce more varied outputs, while lower temperatures generate more consistent results. The batch size is a parameter that determines the number of samples processed at once. Larger batch sizes can improve processing speed but increase memory consumption. The response generation system 11 may generate additional parameters beyond those listed above.

That is, the response generation system 11 may generate parameters regarding which generative AI model is to be assigned to each task included in the task execution task, and may generate an optimal prompt to be input into the assigned generative AI model. Additionally, the response generation system 11 may generate parameters for generating the optimal prompt for each task by referencing the usage history.

Thereafter, based on the parameters obtained in step S311, the response generation system 11 may generate a prompt for each task included in the task execution task (S312). A detailed description of how to generate a prompt will be provided later with reference to FIG. 8.

According to the above embodiment, by referencing the user's usage history, the response generation system 11 can determine the optimal parameters for each task included in the task execution task and instruct a specific generative AI model to execute each task. This enables the generation of an optimal output for each task and ultimately allows response data to be generated aligned with the user's intention. Thus, according to the present embodiment, user satisfaction with the service of the generative AI system 10 can be improved.

Meanwhile, in one embodiment, the response generation system 11 may update the task execution plan by referencing at least one of execution history for the first and second tasks included in the task execution task, operational guidelines, or the user database 12. The response generation system 11 may update the task execution plan by referencing execution history of similar tasks, internal or external regulations that must be followed when executing the tasks included in the task execution task, and data referenced by the user of the user terminal 20 when performing tasks similar to those included in the task execution task.

According to the above embodiment, the response generation system 11 may adjust the output data for each task included in the task execution task by referencing not only data stored in the user database 12, but also execution history and operational guidelines, and may thereby generate optimal response data. Thus, according to this embodiment, user satisfaction with the service of the generative AI system 10 can be improved.

A method for generating a task execution plan and corresponding prompts, performed according to some embodiments of the present disclosure, will hereinafter be described with reference to FIG. 8. FIG. 8 is a diagram illustrating a method for generating a task execution plan and corresponding prompts, performed according to some embodiments of the present disclosure. FIG. 8 illustrates a task execution plan and corresponding prompts generated based on the first request content 510, as explained with reference to FIG. 5.

Referring to FIG. 8, a first task execution task 800 defined for the first request content 510 in FIG. 5 may be “Screen Definition for Service CX Planning.” The first task execution task 800 may include a first task 810 regarding image analysis, a second task 820 regarding organizing planning intentions, and a third task 830 regarding screen definition. That is, the response generation system 11 may generate a task execution plan for the first, second, and third tasks 810, 820, and 830 included in the first task execution task 800 to achieve the user's intention on the user terminal 20. The task execution plan may involve performing the first task 810, performing the second task 820 based on the results of the first task 810, and then performing the third task 830 based on the results of the second task 820.

In this example, by querying the user database 12, the response generation system 11 may retrieve the usage history of the user of the user terminal 20, including histories of tasks that have been performed in connection with UX standard screen types and tasks that have been performed in connection with CX planning.

Thereafter, by referencing the retrieved usage history, the response generation system 11 may generate text-based prompts instructing the execution of the first, second, and third tasks 810, 820, and 830. For example, the response generation system 11 may assign the first task 810 to an X model, a generative AI model developed by Company A, the second task 820 to a Y model, a generative AI model developed by Company B, and the third task 830 to a Z model, a generative AI model developed by Company C.

In this case, based on optimal parameters to be input into the X model, the response generation system 11 may generate a first text-based prompt 811 instructing the execution of the first task 810 as follows:
“The input image is a screen draft for service planning. Identify and define a similar screen specification from UX standard screen types.”

At this time, in the first prompt 811, the response generation system 11 may update the internal UX standard screen types regarding “UX standard screen types” by referencing operational guidelines for image analysis, the first task 810.

Based on optimal parameters to be input into the Y model, the response generation system 11 may generate a second text-based prompt 821 instructing the execution of the second task 820 as follows:
“Analyze the input screen and organize the necessary components for screen planning according to UX standard definitions.
Summarize the results in the following format:
Example) Industry, Components.”

Based on optimal parameters to be input into the Z model, the response generation system 11 may generate a third text-based prompt 831 instructing the execution of the third task 830 as follows:
“Based on the input industry and components, organize the input image into a screen specification optimized for the industry.”

At this time, in the third prompt 831, the response generation system 11 may update the industry-optimized screen specification regarding the “screen specification optimized for the industry” by referencing execution history for screen definition, the third task 830.

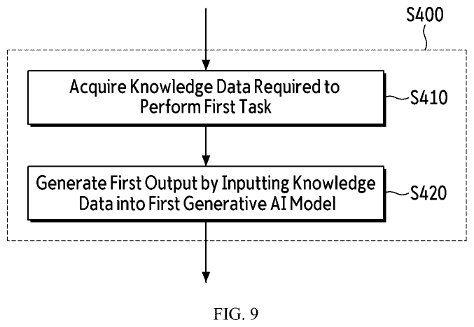

A method for generating an output by inputting each task included in a task execution task into a corresponding generative AI model, according to another embodiment of the present disclosure, will hereinafter be described with reference to FIG. 9. FIG. 9 is a detailed flowchart illustrating some of the steps of the method for generating response data using a generative AI model, as explained with reference to FIG. 2.

Referring to FIG. 9, the response generation system 11 may acquire knowledge data required to perform the first task included in the task execution task from the knowledge data storage 40 (S410). The knowledge data may refer to information necessary for generating an output. The knowledge data storage 40 may include an internal database 41, which is maintained and managed by the same entity operating the generative AI system 10, and an external database 42, which is maintained and managed by an entity different from that operating the generative AI system 10. That is, by searching the internal database 41 and the external database 42, the response generation system 11 may acquire the knowledge data required to perform each task included in the task execution task.

Thereafter, the response generation system 11 may generate a first output by inputting the acquired knowledge data, along with the first task, into the first generative AI model, which is assigned as the AI model responsible for the first task (S420). That is, when generating an output by inputting each task included in the task execution task into a specific generative AI model, the response generation system 11 may utilize both internal and external knowledge data to generate an output for constructing final response data.

According to the above embodiment, by referencing internal and external knowledge data to generate optimal response data for the user's request content, the user experience with the generative AI system 10 can be enhanced.

Meanwhile, in one embodiment, the response generation system 11 may generate a first output by inputting the first task included in the task execution task into the first generative AI model and generate a second output by inputting the second task included in the task execution task into the second generative AI model. That is, the response generation system 11 may utilize the results obtained by executing the first task as an input for executing the second task.

According to the above embodiment, by converting the task execution task into a task execution plan that comprises a sequential workflow and ensuring that each generative AI model fully executes its assigned task, final response data aligned with the user's intention can be generated. That is, by selecting the optimal generative AI model for each task and aggregating the output generated by each model, final response data that accurately reflect the user's intention can be created, thereby maximizing the user experience with the generative AI system 10.

A method for generating response data according to an embodiment of the present disclosure will hereinafter be described with reference to FIG. 10. FIG. 10 is a detailed flowchart illustrating some of the steps of generating response data using a generative AI model, as explained with reference to FIG. 2.

Referring to FIG. 10, the response generation system 11 may determine whether the first and second outputs match the intention corresponding to the received request content (S610). The response generation system 11 may make this determination by comparing the first and second outputs with the checklist summarizing the user's intention, as explained in step S200 of FIG. 2.

Thereafter, if at least one of the first and second outputs does not match the intention corresponding to the received request content, the response generation system 11 may re-perform step S300 of FIG. 2, which involves selecting an AI model for each task from the predetermined pool of the plurality of generative AI models. That is, if the output generated for each task does not align with the user's intention behind the request content, the response generation system 11 may reselect an optimal generative AI model to execute each task, thereby generating an optimal output.

Conversely, if both the first and second outputs match the intention corresponding to the received request content, the response generation system 11 may execute step S700 of FIG. 2, which involves storing feedback data regarding the behavior of the user with respect to the response data in the user database 12 for the user.

According to the above embodiment, by analyzing the request content entered by the user through the user terminal 20, accurately identifying the user's query intention, and generating an optimal output aligned with the user's intention, final response data that best meets the need of each user can be ultimately generated.

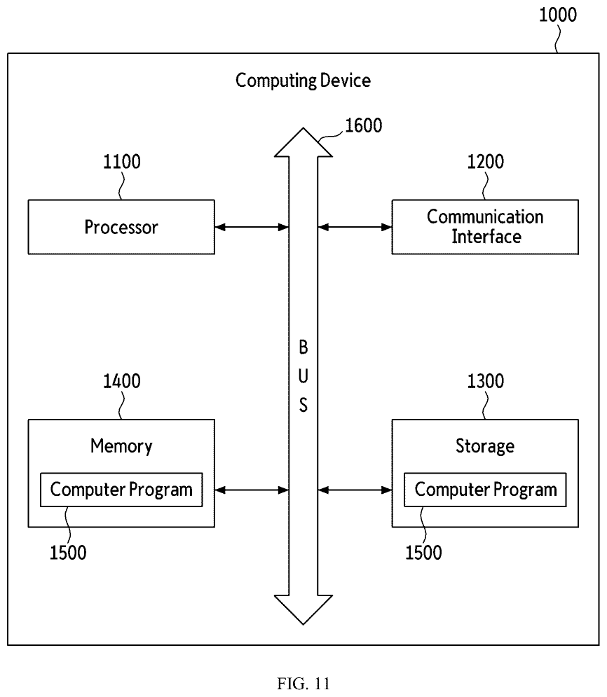

FIG. 11 is a hardware configuration diagram of a computing device according to some embodiments of the present disclosure. Referring to FIG. 11, a computing device 1000 may include at least one processor 1100, a system bus 1600, a communication interface 1200, a memory 1400 that loads a computer program 1500 to be executed by the processor 1100, and a storage 1300 that stores the computer program 1500.

The computing device 1000 in FIG. 11 may represent the hardware structure of one or more computing systems constituting the response generation system 11, as explained with reference to FIG. 1.

The processor 1100 controls the overall operation of each component of the computing system 1000. The processor 1100 may execute computations for at least one application or program for performing methods/operations according to various embodiments of the present disclosure. The memory 1400 stores various types of data, commands, and/or information. To execute the methods/operations according to various embodiments of the present disclosure, the memory 1400 may load one or more computer programs 1500 from the storage 1300. The storage 1300 may non-transitorily store one or more computer programs 1500.

The computer program 1500 may include one or more instructions implementing the methods/operations according to various embodiments of the present disclosure. When the computer program 1500 is loaded into the memory 1400, the processor 1100 may execute the one or more instructions, thereby performing the methods/operations according to various embodiments of the present disclosure.

In one embodiment, the computer program 1500 may include instructions for the operations of: determining the intention corresponding to request content received from a user terminal, by analyzing the request content; defining a task execution task to achieve the intention, the task execution task including a first task and a second task; selecting AI models for the first and second tasks from a pool of a plurality of generative AI models; generating a first output by inputting the first task into a first generative AI model assigned as the AI model responsible for the first task; generating a second output by inputting the second task into a second generative AI model assigned as the AI model responsible for the second task; and aggregating the first and second outputs to generate response data corresponding to the request content. The first generative AI model may be a fine-tuned model obtained using training data from a first domain, and the second generative AI model may be a fine-tuned model obtained using training data from a second domain different from the first domain.

So far, a variety of embodiments of the present disclosure and the effects according to embodiments thereof have been mentioned with reference to FIGS. 1 to 11. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

What is claimed is:

1. A method for generating response data using a generative artificial intelligence (AI) model, performed by a computing system, the method comprising:
determining an intention corresponding to request content received from a user terminal, by analyzing the request content;
defining a task execution task to achieve the intention, the task execution task including a first task and a second task;
selecting an AI model for each of the first and second tasks from a predetermined pool of a plurality of generative AI models;
generating a first output by inputting the first task into a first generative AI model selected as an AI model responsible for the first task;
generating a second output by inputting the second task into a second generative AI model selected as an AI model responsible for the second task; and
generating response data for the request content by aggregating the first and second outputs,
wherein
the first generative AI model is a fine-tuned model obtained using training data from a first domain, and
the second generative AI model is a fine-tuned model obtained using training data from a second domain different from the first domain.

2. The method of claim 1, wherein the determining the intention comprises: retrieving usage history of a user of the user terminal by querying a personalized user database for the user; and generating required information for defining the task execution task by referencing the retrieved usage history.

3. The method of claim 2, wherein the generating the required information comprises: transmitting a query to the user terminal to supplement the required information; and generating the required information by further referencing a response to the query from the user terminal.

4. The method of claim 1, wherein
the defining the task execution task comprises generating a task execution plan that includes a sequential workflow for the first and second tasks to achieve the determined intention, and
the task execution plan includes sequential execution of the first and second tasks.

5. The method of claim 4, wherein the generating the task execution plan comprises:
updating the task execution plan by referencing at least one of execution history for each of the first and second tasks, operational guidelines, or a personalized user database for a user.

6. The method of claim 4, wherein the selecting the AI model for each of the first and second tasks comprises: retrieving usage history of a user of the user terminal by querying a personalized user database for the user; acquiring parameters for generating a first text-based prompt instructing the execution of the first task by referencing the retrieved usage history; and generating a first prompt based on the acquired parameters.

7. The method of claim 1, wherein the generating the first output comprises: acquiring knowledge data required to perform the first task; and generating the first output by inputting the acquired knowledge data into the first generative AI model.

8. The method of claim 1, wherein the generating the second output comprises:
generating the second output by further inputting the first output into the second generative AI model.

9. The method of claim 1, wherein the generating the response data comprises:
determining whether each of the first and second outputs matches the intention; and re-performing the selecting the AI model for each of the first and second tasks when at least one of the first and second outputs does not match the intention.

10. The method of claim 1, further comprising:
storing feedback data regarding a behavior of a user of the user terminal with respect to the response data, in a personalized user database for the user.

11. A system for generating response data using a generative artificial intelligence (AI) model, the system comprising:
a communication interface;
a memory in which a computer program is loaded; and
at least one processor configured to execute the computer program,
wherein
the computer program includes instructions for performing operations of: determining an intention corresponding to request content received from a user terminal, by analyzing the request content; defining a task execution task to achieve the intention, the task execution task including a first task and a second task; selecting an AI model for each of the first and second tasks from a predetermined pool of a plurality of generative AI models; generating a first output by inputting the first task into a first generative AI model selected as an AI model responsible for the first task; generating a second output by inputting the second task into a second generative AI model selected as an AI model responsible for the second task; and generating response data for the request content by aggregating the first and second outputs,
the first generative AI model is a fine-tuned model obtained using training data from a first domain, and
the second generative AI model is a fine-tuned model obtained using training data from a second domain different from the first domain.

12. The system of claim 11, wherein the operation of determining the intention comprises: retrieving usage history of a user of the user terminal by querying a personalized user database for the user; and generating required information for defining the task execution task by referencing the retrieved usage history.

13. The system of claim 12, wherein the operation of generating the required information comprises: transmitting a query to the user terminal to supplement the required information; and generating the required information by further referencing a response to the query from the user terminal.

14. The system of claim 11, wherein
the operation of defining the task execution task comprises generating a task execution plan that includes a sequential workflow for the first and second tasks to achieve the determined intention, and
the task execution plan includes sequential execution of the first and second tasks.

15. The system of claim 14, wherein the operation of generating the task execution plan comprises updating the task execution plan by referencing at least one of execution history for each of the first and second tasks, operational guidelines, or a personalized user database for a user.

16. The system of claim 14, wherein the operation of selecting the AI model for each of the first and second tasks comprises: retrieving usage history of a user of the user terminal by querying a personalized user database for the user; acquiring parameters for generating a first text-based prompt instructing the execution of the first task by referencing the retrieved usage history; and generating a first prompt based on the acquired parameters.

17. The system of claim 11, wherein the operation of generating the first output comprises: acquiring knowledge data required to perform the first task; and generating the first output by inputting the acquired knowledge data into the first generative AI model.

18. The system of claim 11, wherein the operation of generating the second output comprises generating the second output by further inputting the first output into the second generative AI model.

19. The system of claim 11, wherein the operation of generating the response data comprises: determining whether each of the first and second outputs matches the intention; and—performing the operation of selecting the AI model for each of the first and second tasks when at least one of the first and second outputs does not match the intention.

20. A computer program stored in a computer-readable recording medium for executing, by being combined with a computing device, steps of:
determining an intention corresponding to request content received from a user terminal, by analyzing the request content;
defining a task execution task to achieve the determined intention, the task execution task including a first task and a second task;
selecting an artificial intelligence (AI) model for each of the first and second tasks from a predetermined pool of a plurality of generative AI models;
generating a first output by inputting the first task into a first generative AI model selected as an AI model responsible for the first task;
generating a second output by inputting the second task into a second generative AI model selected as an AI model responsible for the second task; and
generating response data for the request content by aggregating the first and second outputs,
wherein
the first generative AI model is a fine-tuned model obtained using training data from a first domain, and
the second generative AI model is a fine-tuned model obtained using training data from a second domain different from the first domain.
